(19) United States
(12) Patent Application Publication
(10) Pub. No.: US 2017/0185373 A1
(43) Pub. Date: Jun. 29, 2017

(54) USER TERMINAL DEVICE, AND MODE CONVERSION METHOD AND SOUND SYSTEM FOR CONTROLLING VOLUME OF SPEAKER THEREOF

(71) Applicant: SAMSUNG ELECTRONICS CO., LTD., Suwon-si (KR)

(72) Inventors: Ji-hyae KIM, Seoul (KR); Won-hee LEE, Seoul (KR); Chang-hoon PARK, Seoul (KR); Yong-jin SO, Seoul (KR)

(73) Assignee: SAMSUNG ELECTRONICS CO., LTD., Suwon-si (KR)

(21) Appl. No.: 15/388,671

(22) Filed: Dec. 22, 2016

(30) Foreign Application Priority Data
Dec. 24, 2015 (KR) 10-2015-0186503

(51) Int. Cl. G06F 3/16; G06F 3/0488; G06F 3/0482; G06F 3/0484

(52) U.S. Cl. CPC G06F 3/165; G06F 3/04847; G06F 3/0488; G06F 3/0482

(57) ABSTRACT

A user terminal apparatus is disclosed. The user terminal apparatus includes a touch screen which senses a multi gesture that is performed by using at least two fingers or other input tools, and a controller which provides an individual volume control mode by which a volume of one speaker apparatus is independently controllable with respect to a volume of the remainder of a plurality of speaker apparatuses, and which is convertible into a group volume control mode in order to combine a plurality of speaker apparatuses into a group such that volumes of the plurality of speaker apparatuses can be jointly controlled in response to the multi gesture sensed via the touch screen while the individual volume control mode is provided.

### CROSS-REFERENCE TO RELATED APPLICATIONS

This application claims priority from Korean Patent Application No. 10-2015-0186503, filed on Dec. 24, 2015 in the Korean Intellectual Property Office, the disclosure of which is incorporated herein by reference in its entirety.

### BACKGROUND

1. Field

Devices and methods consistent with exemplary embodiments relate to a user terminal device, and a mode conversion method and a sound system for controlling a volume of a speaker connected to the user terminal apparatus, and more specifically, to a method for converting into mode in which a user can jointly control volumes in a plurality of speakers connected to a user terminal apparatus.

2. Description of the Related Art

Recently, as the industry has become highly enhanced, all electronic devices are digitized from the analog forms and an acoustic device pursues enhancement of the sound quality while digitization is rapidly supplied.

In particular, a conventional speaker apparatus may only reproduce a sound source provided over a wire. However, a recent speaker apparatus may output a sound source content stored in a cloud server by being wirelessly connected to an access point (AP). Further, such speaker apparatuses may be arranged separately at a plurality of places, and output same content or different contents from each other.

In order to adjust volumes of a plurality of speaker apparatuses under the environment described above, a user may experience an inconvenience in order to repeatedly adjust a respective volume of each speaker apparatus separately.

### SUMMARY

Exemplary embodiments may overcome the above disadvantages and other disadvantages not described above. Also, the present inventive concept is not required to overcome the disadvantages described above, and an exemplary embodiment may not overcome any of the problems described above.

According to an exemplary embodiment, a technical objective is to provide a method for jointly controlling volumes in a plurality of speaker apparatuses connected to a user terminal apparatus.

Further, another technical objective is to provide a method for controlling a volume of each individual speaker apparatus or volumes of a plurality of speaker apparatuses altogether.

According to an exemplary embodiment, the user terminal apparatus configured to convert a mode of controlling volumes of a plurality of speaker apparatuses may include a touch screen configured to sense a gesture that is performed by using at least two input tools, and a controller configured to provide an individual volume control mode that relates to controlling a volume of a single speaker apparatus independently with respect to respective volumes of a remainder of a plurality of speaker apparatuses, and to convert the mode into a group volume control mode in order to combine the plurality of speaker apparatuses into a group such that volumes of a plurality of speaker apparatuses can be jointly controlled in response to the sensed gesture while the individual volume control mode is provided.

Further, when the individual volume control mode is provided, the controller may control the touch screen to display a plurality of user interface (UI) elements which respectively correspond to controlling individual volumes which respectively relate to corresponding ones from among the plurality of speaker apparatuses.

Further, when the group volume control mode is provided, the controller may control the touch screen to display one UI element which corresponds to controlling a total volume that relates to a whole of the plurality of speaker apparatuses.

The user terminal apparatus may further include a communication interface configured to communicate with a plurality of speaker apparatuses or with a hub device connected to a plurality of speaker apparatuses. The touch screen may sense a user gesture on the touch screen while the mode is being converted into the group volume control mode, and the controller may control the communication interface to transmit a volume control command which relates to controlling the volumes of the plurality of speaker apparatuses in the group to each of the plurality of speaker apparatuses or to the hub device in response to the sensed user gesture.

Further, the user gesture may include one from among a user gesture of swiping the gesture that is performed by using at least two input tools, or a user gesture sensed again after the touch of the gesture that is performed by using at least two input tools is ended.

Further, the controller may determine a level of each respective volume of the plurality of speaker apparatuses according to a movement amount of the user gesture.

The user terminal apparatus may further include a communication interface configured to communicate with the plurality of speaker apparatuses or with a hub device connected to the plurality of speaker apparatuses. The touch screen may sense a user gesture on the touch screen while the individual volume control mode is provided, and the controller may control the communication interface to transmit a volume control command that relates to controlling a volume of one speaker apparatus among a plurality of speaker apparatuses to the one speaker apparatus or to the hub device in response to the sensed user gesture.

Further, the controller may convert the mode into the individual volume control mode in response to the gesture that is performed by using at least two input tools sensed on the touch screen while the group volume control mode is provided.

Further, the gesture that is performed by using at least two input tools may include one from among a pinch-in gesture of gathering fingers while touching the touch screen with at least two input tools, and a swipe gesture of swiping in one direction while touching the touch screen with at least two input tools.

Still further, according to an exemplary embodiment, a sound output system may include a plurality of speaker apparatuses, and a user terminal apparatus configured to provide an individual volume control mode that relates to controlling a volume of a single speaker apparatus independently with respect to respective volumes of a remainder of the plurality of speaker apparatuses, and to convert the mode into a group volume control mode in order to combine a plurality of speaker apparatuses into a group such that volumes of a plurality of speaker apparatuses can be jointly controlled when a gesture that is performed by using at least two input tools is sensed while the individual volume control mode is provided.

Still further, according to an exemplary embodiment, a mode conversion method for controlling volumes of a plurality of speaker apparatuses with a user terminal apparatus may include providing an individual volume control mode that relates to controlling a volume of a single speaker apparatus independently with respect to respective volumes of a remainder of the plurality of speaker apparatuses, sensing a gesture that is performed by using at least two input tools of a user on a touch screen while the individual volume control mode is provided, and converting the mode into a group volume control mode in order to combine the plurality of speaker apparatuses into a group such that volumes of a plurality of speaker apparatuses can be jointly controlled in response to the sensed gesture that is performed by using at least two input tools.

Further, the providing individual volume control mode may include displaying, on a screen a plurality of UI elements which respectively correspond to controlling individual volumes which respectively relate to corresponding ones from among the plurality of speaker apparatuses.

Further, the converting the mode into the group volume control mode may include displaying, on the screen, one UI element which corresponds to controlling a total volume that relates to a whole of the plurality of speaker apparatuses.

The mode conversion method may further include sensing a user gesture on the touch screen while the mode is being converted into the group volume control mode, and transmitting a volume control command which relates to controlling respective volumes of a plurality of speaker apparatuses in the group to each of the plurality of speaker apparatuses or to a hub device connected to a plurality of speaker apparatuses in response to the sensed user gesture.

Further, the user gesture may include one from among a gesture of swiping the gesture that is performed by using at least two input tools and a user gesture sensed again after the touch of the gesture that is performed by using at least two input tools is ended.

The mode conversion method may further include determining a level of each respective volume of the plurality of speaker apparatuses according to a movement amount of the user gesture.

The mode conversion method may further include sensing a user gesture on the touch screen while the individual volume control mode is provided, and transmitting a volume control command that relates to controlling a volume of one speaker apparatus among a plurality of speaker apparatuses to the one speaker apparatus or to a hub device connected to the one speaker apparatus in response to the sensed user gesture.

The mode conversion method may further include converting the mode into the individual volume control mode in response to the gesture that is performed by using at least two input tools being sensed on the touch screen while the group volume control mode is provided.

Further, the gesture that is performed by using at least two input tools may include one from among a pinch-in gesture of gathering fingers while touching the touch screen with at least two input tools, or a swipe gesture of swiping in one direction while touching the touch screen with at least two input tools.

Meanwhile, according to another exemplary embodiment, one or more non-transitory computer readable recording mediums storing a program for converting a mode that relates to controlling respective volumes of a plurality of speaker apparatuses are provided, in which the program may be configured to perform providing an individual volume control mode that relates to controlling a volume of a single speaker apparatus independently with respect to respective volumes of a remainder of the plurality of speaker apparatuses, and converting the mode into a group volume control mode in order to combine the plurality of speaker apparatuses into a group such that volumes of a plurality of speaker apparatuses can be jointly controlled in response to a gesture that is performed by using at least two input tools of a user being sensed on the touch screen while the individual volume control mode is provided.

According to the above various exemplary embodiments, the user terminal apparatus may swiftly convert into either of the mode to control a volume of each speaker apparatus and the mode to jointly control volumes in a plurality of speaker apparatuses based on the user gesture.

Further, according to the above various exemplary embodiments, the mode to control a volume of each speaker apparatus and the mode to jointly control volumes in a plurality of speaker apparatuses may be clearly distinguished, which thus enhances intuitiveness and convenience of a user of the user terminal apparatus.

Other effects that may result or be expected from an exemplary embodiment will be directly or indirectly described below. In particular, various effects that may be expected according to an exemplary embodiment will be described below in a later part of the specific explanation.

### BRIEF DESCRIPTION OF THE DRAWINGS

The above and/or other aspects will be more apparent by describing certain exemplary embodiments with reference to the accompanying drawings.

FIG. 1 is a diagram illustrating a configuration of a sound output system, according to an exemplary embodiment.

FIGS. 2A and 2B are diagrams illustrating a user interface screen of a user terminal apparatus to control a volume of a speaker apparatus, according to an exemplary embodiment.

FIG. 3 is a block diagram illustrating a brief configuration of a user terminal apparatus, according to an exemplary embodiment.

FIG. 4 is a block diagram illustrating a detailed configuration of a user terminal apparatus, according to an exemplary embodiment.

FIG. 5 is a diagram explaining a configuration of software stored in a user terminal apparatus, according to an exemplary embodiment.

FIGS. 6A, 6B, 6C, 6D, 6E, and 6F are diagrams illustrating user interface screens of a user terminal apparatus to control a volume of a speaker apparatus, according to an exemplary embodiment.

FIGS. 7A and 7B are diagrams illustrating user interface screens of a user terminal apparatus to control a volume of a speaker apparatus, according to another exemplary embodiment.

FIGS. 8A, 8B, 8C and 8D are diagrams illustrating user interface screens of a user terminal apparatus to control a volume of a speaker apparatus, according to another exemplary embodiment.

FIGS. 9A and 9B are diagrams illustrating a user interface screen of a user terminal apparatus to control a volume of a speaker apparatus, according to another exemplary embodiment.

FIG. 10 is a flowchart in which a user terminal apparatus controls a volume of a speaker apparatus, according to an exemplary embodiment.

FIG. 11 is a flowchart in which a user terminal apparatus controls a volume of a speaker apparatus, according to another exemplary embodiment.

FIG. 12 is a flowchart in which a user terminal apparatus controls a volume of a speaker apparatus, according to another exemplary embodiment.

### DETAILED DESCRIPTION

The exemplary embodiments may have a variety of modifications and several embodiments. Accordingly, specific exemplary embodiments will be illustrated in the drawings and described in detail in the detailed description part. However, in certain characterizations, the terms such as “comprise,” or “consist of,” and so on are not intended to limit the scope of the characteristics, numbers, and mode of an exemplary embodiment, but should be understood to be encompassing all the modifications, equivalents or alternatives falling under the concepts and technical scope as disclosed. In describing the exemplary embodiments, well-known functions or constructions are not described in detail since they would obscure the specification with unnecessary detail.

The terms such as “first,” “second,” and so on may be used to describe a variety of elements, but the elements should not be limited by these terms. The terms are used only for the purpose of distinguishing one element from another.

The terms used herein are solely intended to explain a specific exemplary embodiment, and not to limit the scope of the present disclosure. A singular expression includes a plural expression, unless otherwise specified. It is to be understood that the expressions are used only to designate presence of steps, operations, elements, parts or combination thereof, and not to foreclose the possibility of presence or possible addition of one or more other numbers, steps, operations, elements, parts or combination thereof.

According to an exemplary embodiment, ‘module’ or ‘unit’ may perform at least one function or operation, and may be implemented to be hardware, software or combination of hardware and software. Further, a plurality of ‘modules’ or a plurality of ‘units’ may be integrated into at least one module and implemented to be at least one processor (not illustrated), except for a ‘module’ or ‘unit’ which needs to be implemented to be specific hardware.

According to an exemplary embodiment, when it is stated that one element (e.g., first element) is “(operatively or communicatively) coupled with/to” or “connected to” another element (e.g., second element), it should be understood that the one element may be directly connected to the another element, or connected to the another element through yet another element (e.g., third element). Meanwhile, when it is stated that one element (e.g., first element) is “directly coupled with/to” or “directly connected to” another element (e.g., second element), it can be understood that there is no other element (e.g., third element) present between the one element and another element.

According to an exemplary embodiment, a user gesture may include a “multi” gesture which requires the use of two or more input tools, or a single gesture which requires the use of one input tool. The input tool may be a user's finger, a stylus pen, or a digitizer pen, for example.

Further, the user gesture may include any of a touch gesture, a drag gesture, a pinch-in gesture, a pinch-out gesture, or a touch release gesture. Herein, the drag gesture may include a swipe gesture, and a gesture of lifting off after touch gesture may be defined as a tap gesture. Further, the user gesture may include a touch gesture to directly contact a touch panel or a display, and a hovering gesture which is a non-contact touch.

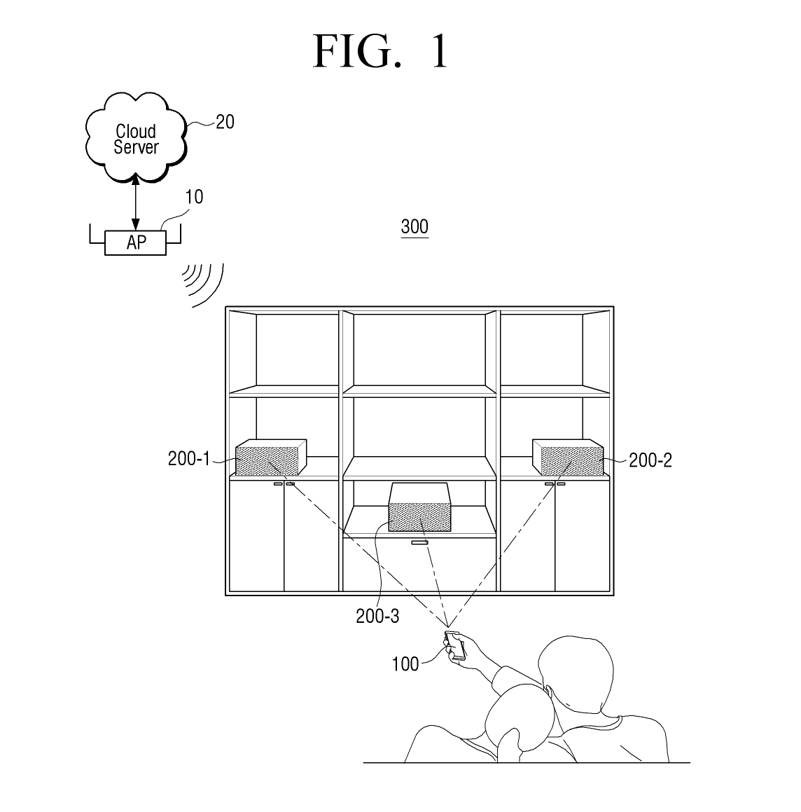

FIG. 1 is a diagram illustrating a configuration of a sound output system 300, according to an exemplary embodiment.

Referring to FIG. 1, the sound output system 300 may be composed of a plurality of speaker apparatuses 200-1, 200-2, 200-3 and a user terminal apparatus 100.

A plurality of speaker apparatuses 200-1, 200-2, 200-3 may be positioned externally to the user terminal apparatus 100. Further, at least one among a plurality of speaker apparatuses 200-1, 200-2, 200-3 may be a speaker included in the user terminal apparatus 100.

A plurality of speaker apparatuses 200-1, 200-2, 200-3 may be each connected to an external cloud server 20 through a hub device 10 (e.g., access point (AP)), or receive and output music content from the external cloud server 20. Further, a plurality of speaker apparatuses 200-1, 200-2, 200-3 may be each connected to the user terminal apparatus 100 via the hub device 10, or receive and output music content from the user terminal apparatus 100. Further, a plurality of speaker apparatuses 200-1, 200-2, 200-3 may be each coupled directly with the user terminal apparatus 100 or the external cloud server 20 without a relay, and receive and output music content from the user terminal apparatus 100 or the external cloud server 20. Herein, a plurality of speaker apparatuses 200-1, 200-2, 200-3 may each receive and output different music contents from each other. However, this is merely one of various exemplary embodiments. Accordingly, a plurality of speaker apparatuses 200-1, 200-2, 200-3 may each output audio signals of a plurality of channels regarding the same music content. For example, the first speaker apparatus 200-1 may receive and output audio signals of a right channel with respect to the music content, the second speaker apparatus 200-2 may receive and output audio signals of a left channel with respect to the music content, and the third speaker apparatus 200-3 may receive and output audio signals of a woofer channel with respect to the music content.

According to an exemplary embodiment, it is mainly described herein that a plurality of speaker apparatuses 200-1, 200-2, 200-3 may each receive and output music content from the external cloud server 20 via the hub device 10 for convenience of explanation. However, exemplary embodiments of the present disclosure may not be limited to the above situation, and may be applied to all the cases described herein.

Playlist information or address information may be previously registered on each of the plurality of speaker apparatuses 200-1, 200-2, 200-3. Therefore, the plurality of speaker apparatuses 200-1, 200-2, 200-3 may receive and output music content from the external cloud server 20 or the user terminal apparatus 100 based on the previously registered playlist information or address information. Meanwhile, the address information or playlist information which is stored in each of a plurality of speaker apparatuses 200-1, 200-2, 200-3 may be same or different from each other.

A plurality of speaker apparatuses 200-1, 200-2, 200-3 may output the music content stored in the cloud server 20 or the user terminal apparatus 100 by using a streaming method, download and temporarily store music content, and output the music content which is temporarily stored.

In FIG. 1, the user terminal apparatus 100 may search a plurality of speaker apparatuses 200-1, 200-2, 200-3. Further, the user terminal apparatus 100 may display information relating to the searched speaker apparatuses on a screen. For example, the user terminal apparatus 100 may be connected to the hub device 10, search the speaker apparatuses 200-1, 200-2, 200-3 connected to the hub device 10, and display information relating to the searched speaker apparatuses on the screen. The speaker apparatus information may include any of speaker apparatus name information, play content information, current volume information, speaker apparatus position information, and speaker apparatus channel information, for example.

Meanwhile, although FIG. 1 illustrates that only the three speaker apparatuses 200-1, 200-2, 200-3 are arranged within the sound output system 300, three or more speaker apparatuses may be included in actual implementation. Further, it is illustrated herein that the three speaker apparatuses 200-1, 200-2, 200-3 are arranged in one space; however, they may be in places that are spaced apart from a wall in actual implementation.

Further, although FIG. 1 illustrates that a plurality of speaker apparatuses 200-1, 200-2, 200-3 and the user terminal apparatus 100 are wirelessly connected via the hub device 10, the plurality of speaker apparatuses 200-1, 200-2, 200-3 and the user terminal apparatus 100 may be connected directly and wirelessly. Further, although it is illustrated herein that the plurality of speaker apparatuses 200-1, 200-2, 200-3 and the user terminal apparatus 100 are wirelessly connected via the hub device 10, each apparatus may be connected in a wired manner in actual implementation. Further, the plurality of speaker apparatuses 200-1, 200-2, 200-3 and the user terminal apparatus 100 may be connected directly and in a wired manner.

Further, although FIG. 1 illustrates that a plurality of speaker apparatuses 200-1, 200-2, 200-3 and the user terminal apparatus 100 are connected to the one hub device 10, the plurality of speaker apparatuses 200-1, 200-2, 200-3 and the user terminal apparatus 100 may be connected to a plurality of hub devices when being connected within one network.

Further, although it is illustrated herein that the hub device 10 and the cloud server 20 are directly connected, another device such as router or internet network may be arranged on the hub device 10 and the cloud server 20.

Further, although FIG. 1 illustrates that the speaker apparatuses 200-1, 200-2, 200-3 are implemented to be general speakers outputting audio only, this is merely one of various exemplary embodiments. They may be implemented to be electronic apparatuses including the speaker that can output audio, such as a smart phone, a smart television (TV), a tablet personal computer (PC), a laptop PC, and a desktop PC.

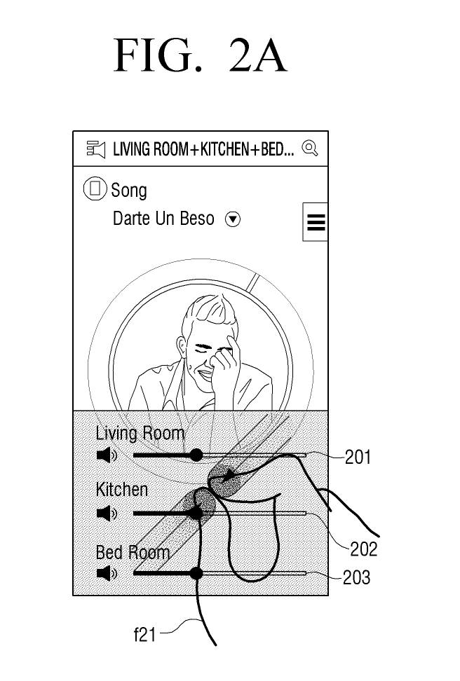

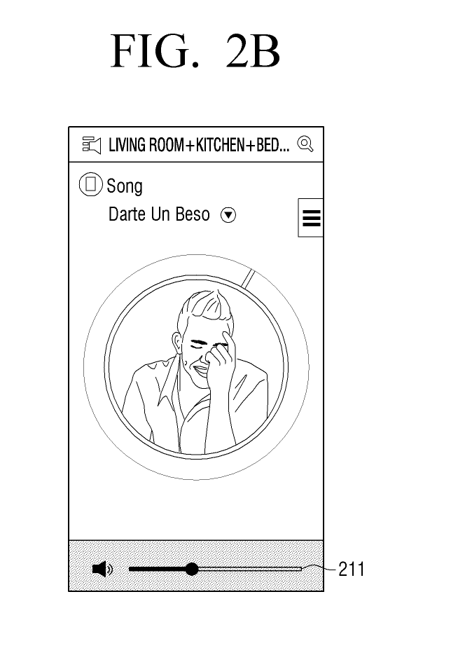

FIGS. 2A and 2B are diagrams illustrating a user interface screen of the user terminal apparatus 100 to control a volume of the speaker, according to an exemplary embodiment.

Referring to FIG. 2A, the user terminal apparatus 100 may provide an individual volume control mode that relates to independently controlling each respective volume of a plurality of speaker apparatuses 200-1, 200-2, 200-3. While providing the individual volume control mode, the user terminal apparatus 100 may display a plurality of user interface (UI) elements 201, 202, 203 which respectively relate to controlling individual volumes that respectively correspond to a plurality of speaker apparatuses 200-1, 200-2, 200-3 on the screen. A plurality of UI elements 201, 202, 203 may be composed of a bar and a pointer that is movable along the bar, for example.

In this situation, in response to sensing a user gesture that relates to manipulating one UI element among a plurality of UI elements 201, 202, 203, the user terminal apparatus 100 may transmit a volume control command to a speaker that corresponds to one UI element. The speaker that corresponds to one UI element may output music content with a volume controlled according to the received volume control command.

Further, while the individual volume control mode is provided, the user terminal apparatus 100 may sense a multi gesture (i.e., a gesture that is performed by using at least two input tools) f21 of a user on the touch screen. The multi gesture f21 may be a pinch-in gesture of gathering fingers on one point after multi-touching (i.e., touching by using at least two fingers or other types of input tools).

In response to the sensed multi gesture f21, as illustrated in FIG. 2B, the user terminal apparatus 100 may convert the mode into a group volume control mode, from the individual volume control mode, in order to combine a plurality of speaker apparatuses 200-1, 200-2, 200-3 into a group such that volumes of the plurality of speaker apparatuses 200-1, 200-2, 200-3 can be jointly controlled. For example, the user terminal apparatus 100 may display one UI element 211 that relates to controlling a total volume that corresponds to a whole of the plurality of speaker apparatuses 200-1, 200-2, 200-3 on the screen. One UI element 211 may be composed of a bar, and a pointer that is movable along the bar, for example.

In this situation, in response to sensing a user gesture that relates to manipulating one UI element 211, the user terminal apparatus 100 may transmit a volume control command to control a total volume of a plurality of speaker apparatuses in the group 200-1, 200-2, 200-3 to each of the plurality of speaker apparatuses 200-1, 200-2, 200-3 or to the hub device 10 connected to the plurality of speaker apparatuses 200-1, 200-2, 200-3. Each of the plurality of speaker apparatuses 200-1, 200-2, 200-3 may output music content with a volume controlled according to the received volume control command.

In this case, the volume control command may include respective volume values to be outputted by each of a plurality of speaker apparatuses 200-1, 200-2, 200-3 or values indicating a control degree. Further, the volume control command may include volume values to be outputted by one speaker apparatus from among the plurality of speaker apparatuses 200-1, 200-2, 200-3 or values indicating a control degree. Further, the volume control command may include volume values to be outputted by a whole of the plurality of speaker apparatuses 200-1, 200-2, 200-3 or values indicating a control degree.

For example, when a volume of the speaker apparatus may be expressed with values that fall within a range of 1 to 100, and a current volume of a specific speaker apparatus is 90, and a volume value controlled by a user is 50, the volume control command may indicate a ‘volume value to be outputted’ by indicating ‘Adjust volume to 50’. Further, the volume control command may indicate a ‘value indicative of control degree’ by indicating ‘Adjust a current volume by −40.’

The sound output system 300 according to the exemplary embodiment described above may easily control a volume of a plurality of speaker apparatuses 200-1, 200-2, 200-3 in the user terminal apparatus 100. Therefore, user convenience is enhanced.

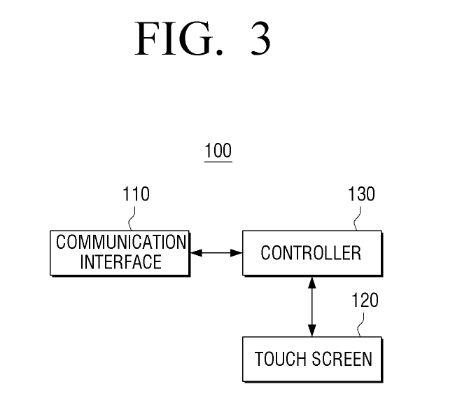

FIG. 3 is a block diagram illustrating a brief configuration of the user terminal apparatus 100, according to an exemplary embodiment. In particular, the user terminal apparatus 100 of FIG. 3 may be implemented to be any of various types of devices such as a TV, a PC, a laptop PC, a mobile phone, a tablet PC, a PDA, an MP3 player, a kiosk, an electronic frame, and so on. In actual implementation where a portable type of device such as a mobile phone, a tablet PC, a PDA, an MP3 player, and a laptop PC is applied, such a device may be referred to as a ‘mobile device’. However, the devices will be collectively referred to below as a ‘user terminal apparatus’ for convenience of explanation.

Referring to FIG. 3, the user terminal apparatus 100 may be composed of a communication interface 110, a touch screen 120 and a controller 130.

The communication interface 110 may search a plurality of speaker apparatuses 200-1, 200-2, 200-3 positioned within the network. In particular, the communication interface 110 may search the speaker apparatus among the electronic devices positioned within the network to which the hub device 100 belongs.

Further, the communication interface 110 may receive device information from a plurality of speaker apparatuses 200-1, 200-2, 200-3 that can be connected to the user terminal apparatus 100. In particular, the communication interface 110 may receive device information from each of the searched speaker apparatuses. Herein, the device information may include any of speaker apparatus name information, current volume information, current play content information, IP address information, and so on.

The communication interface 110 may transmit a volume control command to at least one speaker apparatus selected by a user from among a plurality of speaker apparatuses 200-1, 200-2, 200-3. Herein, the volume control command may be a volume value to be outputted or a value indicating a control degree.

The touch screen 120 may display icons of various applications previously installed on the user terminal apparatus 100. Further, the touch screen 120 may sense a user gesture to select any one among the displayed icons of the various applications.

When icon selected by a user is a speaker application, the touch screen 120 may display a list that relates to a plurality of speaker apparatuses that can be controlled by a user. Herein, when a user selects any one speaker apparatus, the touch screen 120 may display the device information that relates to the selected speaker apparatus and another speaker apparatus outputting the same content as the selected speaker apparatus.

Further, although the above exemplary embodiment describes that only the device information of the speaker apparatus outputting the same content may be primarily filtered and displayed, it is based on such assumption that there are a preset number or more of the speaker apparatuses available for connection. In this aspect, when the speaker apparatuses available for connection is implemented to be equal to or less than a preset number of devices, device information of all the speaker apparatuses available for connection may be displayed without the filtering. Further, although an apparatus outputting the same content is implemented to be used as filtering information, filtering may be performed according to another condition such as places of the speaker apparatuses, whether sound is outputted or not, and so on.

Further, the touch screen 120 may display UI elements which relate to controlling a volume of at least one speaker apparatus from among a plurality of speaker apparatuses 200-1, 200-2, 200-3. In this case, the touch screen 120 may sense a user gesture which relates to manipulating the UI elements. For example, the touch screen 120 may sense a user's drag gesture to move a pointer on UI elements. Further, the touch screen 120 may sense user touch gesture to select a number key or touch ‘+’ or ‘−’ element.

The touch screen 120 may vary and display volume information of the speaker apparatus selected by a user in response to the user gesture.

The controller 130 may control each unit of the user terminal apparatus 100. In particular, when a user selects a speaker application, the controller 130 may drive the speaker application. When the speaker application is executing, the controller 130 may control the communication interface 110 so as to search the speaker apparatus that can be connected.

Further, the controller 130 may provide the individual volume control mode that can control a volume of one speaker apparatus independently with respect to respective volumes of a remainder of a plurality of speaker apparatuses 200-1, 200-2, 200-3. When a multi gesture is sensed via the touch screen 120 while the individual volume control mode is provided, the controller 130 may convert the mode into the group volume control mode in order to combine a plurality of speaker apparatuses 200-1, 200-2, 200-3 into a group such that volumes of a plurality of speaker apparatuses 200-1, 200-2, 200-3 can be jointly controlled. In this case, the multi gesture may be a pinch-in gesture of gathering fingers while multi-touching the touch screen 120, or a multi swipe gesture of swiping in one direction while multi-touching the touch screen 120.

According to an exemplary embodiment, when the individual volume control mode is provided, the controller 130 may control the touch screen 120 to display a plurality of UI elements that relate to controlling individual volumes which respectively correspond to a plurality of speaker apparatuses 200-1, 200-2, 200-3.

According to an exemplary embodiment, when the group volume control mode is provided, the controller 130 may control the touch screen 120 to display one UI element which relates to controlling a total volume that corresponds to a whole of a plurality of speaker apparatuses 200-1, 200-2, 200-3.

According to an exemplary embodiment, while converting the mode into the group volume control mode, the controller 130 may control the communication interface 100 to transmit a volume control command which relates to controlling volumes of a plurality of speaker apparatuses in the group 200-1, 200-2, 200-3 to each of a plurality of speaker apparatuses 200-1, 200-2, 200-3 or to the hub device 100 connected to a plurality of speaker apparatuses 200-1, 200-2, 200-3 in response to the user gesture that is sensed by the touch screen 120. In this case, the user gesture may be a gesture of dragging (e.g., swiping) the multi gesture or a user gesture sensed again after the touch of the multi gesture is lifted off. In this case, the controller 130 may determine a respective volume regarding each of a plurality of speaker apparatuses 200-1, 200-2, 200-3 according to a movement amount of the user gesture.

According to an exemplary embodiment, while the individual volume control mode is provided, the controller 130 may control the communication interface 110 to transmit a volume control command to one speaker apparatus or to the hub device 10 connected to the one speaker apparatus in response to the user gesture sensed by the touch screen 120.

According to an exemplary embodiment, while the group volume control mode is provided, the controller 130 may convert into the individual volume control mode that can control a volume of one speaker apparatus independently with respect to respective volumes of a remainder of a plurality of speaker apparatuses 200-1, 200-2, 200-3 in response to the user multi gesture sensed by the touch screen 120.

According to the above exemplary embodiments, a user may simply convert the volume control mode regarding a plurality of speaker apparatuses 200-1, 200-2, 200-3.

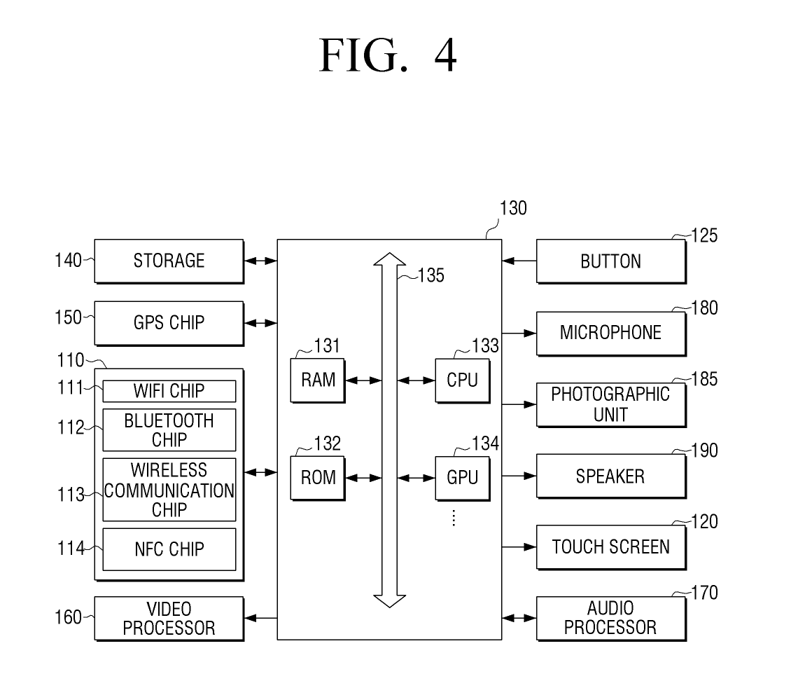

Meanwhile, although the above illustrates and describes only the brief configuration of the user terminal apparatus 100, various units may be additionally included in actual implementation. The relevant additional units will be explained below by referring to FIG. 4.

FIG. 4 is a block diagram illustrating a detailed configuration of the user terminal apparatus 100, according to an exemplary embodiment.

Referring to FIG. 4, the user terminal apparatus 100 may include the communication interface 110, the touch screen 120, the controller 130, a storage 140, a global positioning system (GPS) chip 150, a video processor 160, an audio processor 170, a button 125, a microphone 180, a photographic unit 185, and a speaker 190.

The communication interface 110 is provided to perform communication with various types of external devices according to various types of communication methods. The communication interface 110 may include a wireless fidelity (WiFi) chip 111, a Bluetooth chip 112, a wireless communication chip 113, and a near-field communication (NFC) chip 114. The controller 130 may perform communication with various external devices by using the communication interface 110.

The WiFi chip 111 and the Bluetooth chip 112 may perform communication respectively according to a WiFi method and a Bluetooth method. When the WiFi chip 111 or the Bluetooth chip 112 is used, various connecting information such as a service set identifier (SSID) or session key may be first transceived, communication may be connected by using the connecting information, and various information may be transceived. The wireless communication chip 113 indicates a chip which is configured to perform communication according to various communication standards such as IEEE, Zigbee, 3G (3^{rd} Generation), 3GPP (3^{rd} Generation Partnership Project), and LTE (Long Term Evolution). The NFC chip 114 indicates a chip which is configured to operate with an NFC (Near Field Communication) method using 13.56 MHz among various RF-ID frequency bandwidths such as 135 kHz, 13.56 MHz, 433 MHz, 860-960 MHz, and 2.45 GHz.

The touch screen 120 may display information that relates to the speaker apparatus as described above, and display a user interface window to receive inputting of volume control manipulation. The touch screen 120 may be implemented to use various formats of the display such as LCD (Liquid Crystal Display), OLED (Organic Light Emitting Diodes) display, and PDP (Plasma Display Panel). The touch screen 120 may include a driving circuit that may be implemented to be an a-si TFT (i.e., non-crystalline silicon thin film transistor) display, a LTPS (low temperature poly silicon) TFT, and an OTFT (organic TFT), and a backlight unit. Further, the touch screen 120 may be implemented to be a flexible display.

Meanwhile, the touch screen 120 may include a touch sensor which is configured to sense a user touch gesture. The touch sensor may be implemented to be various types of sensors such as capacitive, decompressive, and piezoelectric. The capacitive sensor is configured to use a dielectric material coated on a surface of the touch screen and calculate a touch coordinate by sensing micro electricity excited by the user body when a part of the user body touches on a surface of the touch screen. The decompressive sensor is configured to include two electrode plates within the touch screen and calculate a touch coordinate by sensing the electrical current to flow when a user touches the screen and the upper and lower plates of the touched point contact each other. Besides, when the user terminal apparatus 100 supports a pen inputting function, the touch screen 120 may sense a user gesture that is performed by using input tools such as a pen as well as user fingers. When the input tools include a stylus pen including a coil, the user terminal apparatus 100 may include a magnetic field sensor that can sense the magnetic field varied by the coil within the stylus pen. Therefore, an approaching gesture, i.e., a hovering gesture may be sensed as well as touch gesture.

Meanwhile, although the above describes that one touch screen 120 performs both the display function and the touch gesture sensing function, the display function and the gesture sensing function may be performed in different units in actual implementation. Thus, the touch screen 120 may be implemented by combining the display apparatus that can only display the video and a touch panel that can only sense a touch.

The storage 140 may store various programs and data necessary for operation of the user terminal apparatus 100. In particular, the storage 140 may store programs and data to create various UIs constituting the user interface window. Further, the storage 140 may store device information that relates to the speaker apparatus received via the communication interface 110.

The storage 140 may store a plurality of applications. In this case, the storage 140 may store a speaker application for operation of an apparatus according to one or more exemplary embodiments.

The controller 130 may display the user interface window on the touch screen 120 by using the programs and data stored in the storage 140. Further, when a user touch is performed on specific area of the user interface window, the controller 130 may perform a control operation that corresponds to the touch.

The controller 130 may include random access memory (RAM) 131, read-only memory (ROM) 132, central processing unit (CPU) 133, GPU (Graphic Processing Unit) 134, and a bus 135. RAM 131, ROM 132, CPU 133, and GPU 134 may be connected each other via the bus 135.

CPU 133 may access to the storage 140, and perform a boot operation by using the stored operating system (O/S) in the storage 140. Further, CPU 133 may perform various operations by using the various programs, contents and data stored in the storage 140.

ROM 132 may store command sets for the system booting. When a turn-on command is inputted and the electrical power is provided, CPU 133 may copy the stored O/S in the storage 140 to RAM 131 according to the stored commands in ROM 132, and boot the system by implementing the O/S. When the booting completes, CPU 133 may copy the various programs stored in the storage 140 to RAM 131 and perform various operations by implementing the programs copied to RAM 131.

GPU 134 may display a UI on the touch screen when the booting of the user terminal apparatus 100 is completed. In particular, GPU 134 may generate a screen that includes various objects such as icons, images and texts by using a calculator (not illustrated) and a renderer (not illustrated). The calculator may calculate feature values such as a coordinate value, a shape, a size and a color in which each object will be displayed according to a layout of the screen. The renderer may generate various layouts of screens including objects based on the feature values calculated in the calculator. The screens (or user interface window) generated in the renderer may be provided to the touch screen 120, and displayed on each of a main display area and a sub display area.

The GPS chip 150 is provided to receive a GPS signal from a GPS (Global Positioning System) satellite and calculate a current position of the user terminal apparatus 100. The controller 130 may calculate a user position by using GPS chip 150 when a navigation program is used or when current user position is needed.

The video processor 160 is provided to process the content received via the communication interface 110 or the video data included in the content stored in the storage 140. The video processor 160 may perform various image processes such as decoding, scaling, noise filtering, frame rate converting, and resolution converting with respect to the video data.

The audio processor 170 is provided to process the content received via the communication interface 110 or the audio data included in the content stored in the storage 140. The audio processor 170 may perform various processes such as decoding, amplifying and noise filtering with respect to the audio data.

The controller 130 may reproduce corresponding content by driving the video processor 160 and the audio processor 170 when a play application is implemented with respect to multimedia content. Herein, the touch screen 120 may display the image frame generated in the video processor 160 on at least one area from among the main display area and the sub display area.

The speaker 190 may output the audio data generated in the audio processor 170.

The button 125 may include any of various types of buttons, such as a mechanical button, a touch pad and a wheel which are formed on a voluntary area such as a front section, a side section, and a back section of the main exterior body.

The microphone 180 is provided to receive user voices or other sounds, and to convert the received sound into audio data. The controller 130 may use the user voice inputted via the microphone 180 during the calling, or convert into audio data and store in the storage 140. Meanwhile, the microphone 180 may be constituted to be a stereo microphone which receives input sound on a plurality of positions.

The photographic unit 185 is provided to photograph a still image or video according to the control of a user. The photographic unit 185 may be implemented to include a plurality of units, such as a front face camera and a back face camera. As described above, the photographic unit 185 may be used as a means to obtain a user image in an exemplary embodiment of tracking user eyesight.

When the photographic unit 185 and the microphone 180 are provided, the controller 130 may perform a control operation according to user voice inputted via the microphone 180 or user motion recognized by the photographic unit 185. The user terminal apparatus 100 may operate in motion control mode or voice control mode. When operating in the motion control mode, the controller 130 may photograph a user by activating the photographic unit 185, and perform a corresponding control operation by tracking changes in the user motion. When operating in the voice control mode, the controller 130 may operate in voice recognize mode to analyze the user voice inputted via the microphone 180 and perform a control operation according to the analyzed user voice.

In the user terminal apparatus 100 supported with the motion control mode or the voice control mode, the voice recognizing technology or the motion recognizing technology may be used in the above described various exemplary embodiments. For example, when a user takes motion to select an object displayed on home screen or speaks a voice command corresponding to the object, the corresponding object may be determined to be selected, and a control operation matched with the object may be performed.

Further, although not illustrated in FIG. 4, the user terminal apparatus 100 may additionally include a universal serial bus (USB) port which is configured to be connected with a USB connector, various external inputting ports which are configured to connect various external components such as headset, mouse, and a local area network (LAN), a DMB chip to receive and process a DMB (Digital Multimedia Broadcasting) signal, and various sensors.

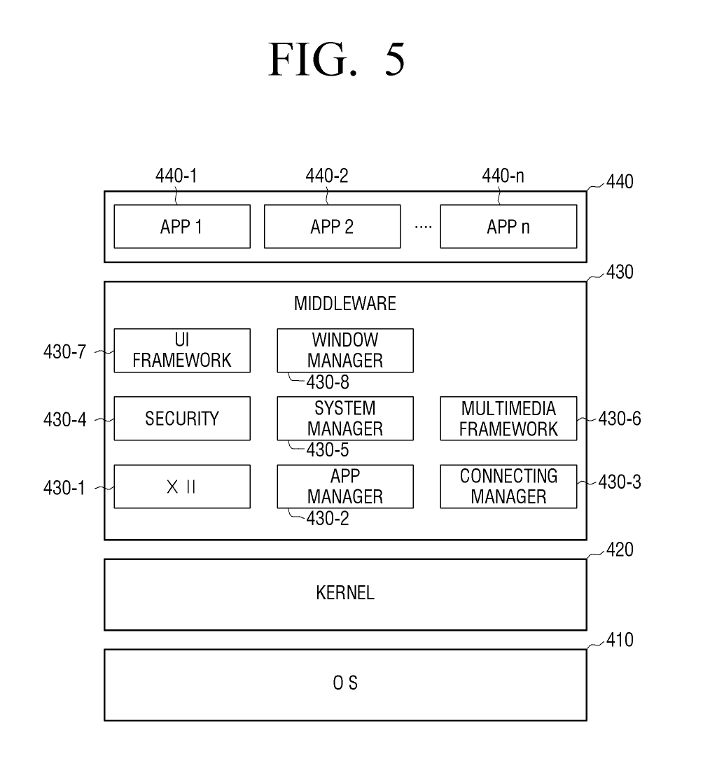

FIG. 5 is a diagram explaining a structure of software stored in the user terminal apparatus 100, according to an exemplary embodiment. Referring to FIG. 5, the storage 140 may store software including OS 410, kernel 420, middleware 430, and application 440.

OS 410 (i.e., Operating System 410) may perform a function of controlling and managing a general operation of hardware. OS 410 is configured to manage basic functions such as hardware management, memory, and security.

The kernel 420 may play a route role to deliver various signals including a touch signal sensed in the touch screen 120 to the middleware 430.

The middleware 430 may include various software modules to control operations of the user terminal apparatus 100. In particular, the middleware 430 may include an X11 module 430-1, an APP manager 430-2, a connecting manager 430-3, a security module 430-4, a system manager 430-5, a multimedia framework 430-6, a UI framework 430-7, and a window manager 430-8.

X11 module 430-1 is a module which is configured to receive various event signals from various hardware provided in the user terminal apparatus 100. Herein, an event may be variously established such as an event to sense a user gesture, an event to move the user terminal apparatus 100 in a specific direction, an event to generate a system alarm, and an event to perform or complete a specific program.

APP manager 430-2 is a module which is configured to manage an implementing state of the various applications 440 installed in the storage 140. When an application implementing event is sensed from X11 module 430-1, APP manager 430-2 may call and perform a corresponding application with respect to the event. For example, when an icon of a user speaker application is selected, APP manager 430-2 may call and perform the speaker application.

The connecting manager 430-3 is a module which is configured to support wired or wireless network connection. The connecting manager 430-3 may include various detail modules such as a DNET module and a universal plug-and-play (UPnP) module. In particular, when the speaker application is performed, the connecting manager 430-3 may search the speaker apparatuses connected to the hub device 10.

The security module 430-4 is a module which is configured to support hardware certification, request permission, and secure storage.

The system manager 430-5 may monitor a state of each unit within the user terminal apparatus 100 and provide the monitoring results to the other modules. For example, when a battery charge amount is low, errors occur, or a communication connecting state is cut off, the system manager 430-5 may provide the monitoring results to UI framework 430-7 and output a notice message or a notice sound.

The multimedia framework 430-6 is a module which is configured to reproduce multimedia contents stored in the user terminal apparatus 100 or provided from external sources. The multimedia framework 430-6 may include a player module, a camcorder module, and a sound processing module. Thereby, the multimedia framework 430-6 may perform the operations of reproducing various multimedia contents, generating and reproducing screens and sounds.

UI framework 430-7 is a module which is configured to provide various UIs to be displayed on the touch screen 120. UI framework 430-7 may include an image compositor module to create various objects, a coordinate compositor module to calculate a coordinate in which an object will be displayed, a rendering module to render the created object on the calculated coordinate, and a 2D/3D UI tool kit to provide tools for creating a 2D or 3D form of UI.

The window manager 430-8 may sense a touch event and other inputting events by using a user body or a pen. When such an event is sensed, the window manager 430-8 may deliver an event signal to UI framework 430-7, such that a corresponding operation with respect to the event can be performed.

In addition, there may be stored various program modules such as a writing module to draw a line on the dragging track when a user touches and drags the screen and an angle calculation module to calculate a pitch angle, a roll angle, and a yaw angle based on the sensor values sensed in a gyro sensor of the user terminal apparatus 100.

The application module 440 may include applications 440-1˜440-n which are respectively configured to support various functions. For example, the application module 440 may include an application module to provide various services such as a speaker application module, a navigation application module, a game module, an electronic book module, a calendar module, and an alarm management module. Such applications may be established to be defaulted, or voluntarily established and used by a user during the utilization. When an icon object of the user interface window is selected, CPU 133 may perform a corresponding application with respect to the selected icon object by using the application module 440.

The software structure illustrated in FIG. 5 is merely one of various exemplary embodiments, and may not be limited hereto. Therefore, some parts may be removed, modified or added according to the need. For example, the storage 140 may be additionally provided with a sensing module which is configured to analyze the signals sensed in various sensors, a messaging module such as messenger program, SMS (Short Message Service) & MMS (Multimedia Message Service) program, and email program, a call information aggregator program module, a voice-over Internet protocol (VoIP) module, and a web browser module.

Meanwhile, as described above, the user terminal apparatus 100 may be implemented to be any of various types of devices such as a mobile phone, a tablet PC, a laptop PC, a PDA, an MP3 player, an electronic frame device, a TV, a PC, and a kiosk. Therefore, the configuration described in FIGS. 4 and 5 may be variously modified according to a type of the user terminal apparatus 100.

In summary, the user terminal apparatus 100 may be implemented to be various formats and configurations. The controller 130 of the user terminal apparatus 100 may support various user interactions according to an exemplary embodiment.

The following disclosure will specifically describe examples of the user interface screen to provide various user interactions according to various exemplary embodiments.

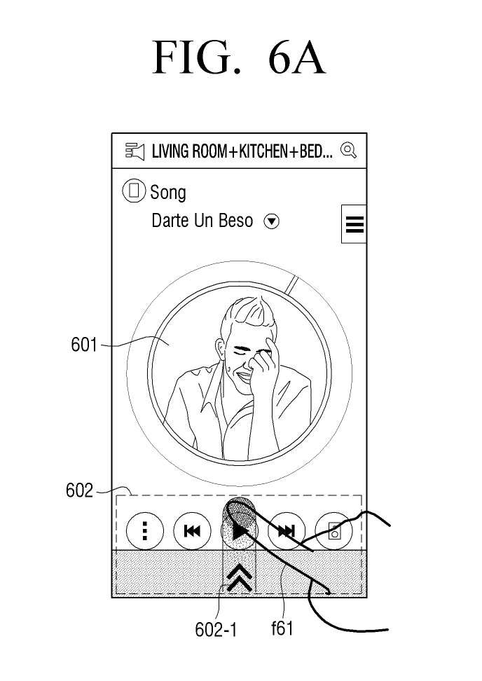

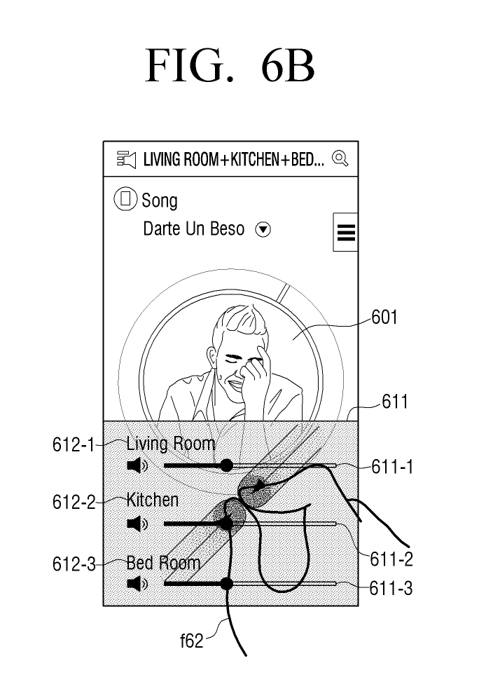

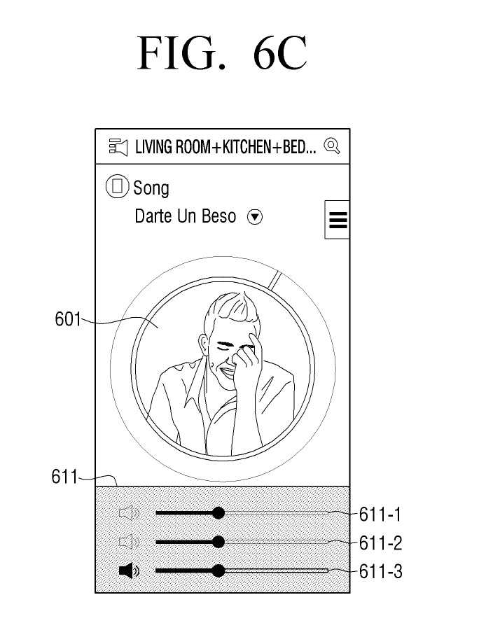

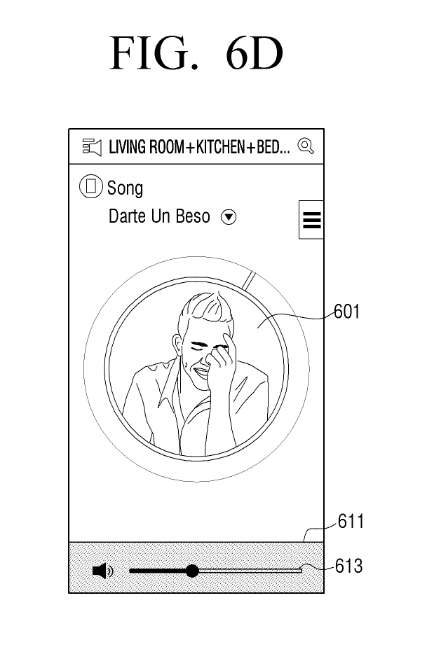

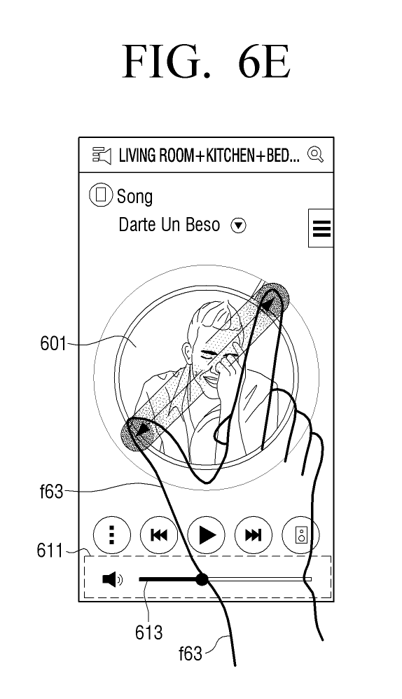

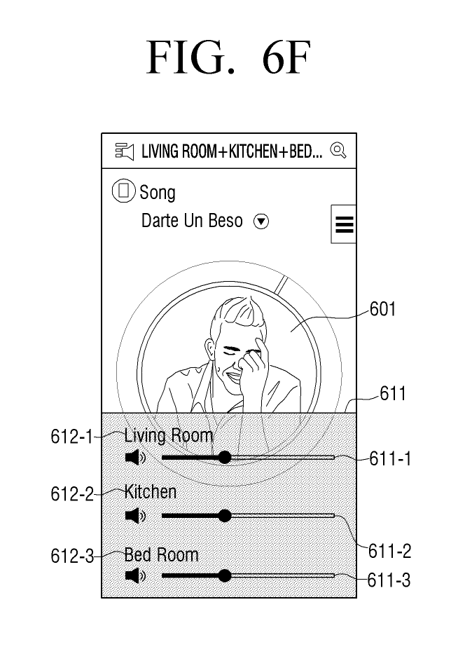

FIGS. 6A, 6B, 6C, 6D, 6E, and 6F are diagrams illustrating user interface screens of the user terminal apparatus 100 to control a volume of the speaker apparatus, according to an exemplary embodiment.

Referring to FIG. 6A, the user terminal apparatus 100 may provide a screen that includes a content information display area 601 and a content control area 602.

The content information display area 601 may display information that relates to music content which is currently being reproduced by a plurality of speaker apparatuses 200-1, 200-2, 200-3. For example, the information of music content may include images such as an album thumbnail of the music content and a singer thumbnail. Meanwhile, when a plurality of speaker apparatuses 200-1, 200-2, 200-3 output different contents with respect to each other, the content information display area 601 may not be displayed.

The content control area 602 may display a plurality of UI elements which are necessary for the controlling of content. The plurality of UI elements may include, for example, a UI element to reproduce or pause content, a UI element to reproduce content positioned after currently reproducing content on an album or a folder including a plurality of contents according to a certain order, and a UI element to reproduce content positioned before currently reproducing content. Further, the content control area 602 may include a UI element 602-1 to control a volume of at least one speaker apparatus from among a plurality of speaker apparatuses 200-1, 200-2, 200-3. In this case, UI element 602-1 may be an element to enter into the content volume control area.

In FIG. 6A, the user terminal apparatus 100 may sense a user gesture f61 to select UI element 602-1 included in the content control area 602. The user gesture f61 may be a touch gesture to touch UI element 602-1 or a drag gesture to drag in one direction while touching UI element 602-1.

In response to the user gesture f61, as illustrated in FIG. 6B, the user terminal apparatus 100 may provide the individual volume control mode which corresponds to independently controlling a respective volume of each of a plurality of speaker apparatuses 200-1, 200-2, 200-3. For example, the user terminal apparatus 100 may display the content volume control area 611 including a plurality of UI elements 611-1, 611-2, 611-3 to control individual volumes which respectively correspond to a plurality of speaker apparatuses 200-1, 200-2, 200-3. A plurality of UI elements 611-1, 611-2, 611-3 may be composed of the bar and the pointer which is movable along the bar, and a pointer position on the bar may indicate a volume of the current speaker apparatus, as illustrated. Further, the content volume control area 611 may display device information 612-1, 612-2, 612-3 of the speaker apparatuses respectively corresponding to a plurality of UI elements 611-1, 611-2, 611-3. The device information may include, for example, a name of the speaker apparatus, a place where the speaker apparatus is positioned, a nickname of the speaker apparatus, and/or channel information of the speaker apparatus. Referring to FIG. 6B, the device information 612-1 of the speaker apparatus corresponding to UI element 611-1 may be a living room, the device information 612-2 of the speaker apparatus corresponding to UI element 611-2 may be a kitchen, and the device information of the speaker apparatus corresponding to UI element 611-3 may be a bedroom 612-3. In this case, when the user gesture to manipulate one UI element among a plurality of UI elements 611-1, 611-2, 611-3 is sensed, the user terminal apparatus 100 may transmit a volume control command to control a volume to the speaker apparatus corresponding to the manipulated UI element. The speaker apparatus corresponding to the manipulated UI element may output music content at a volume controlled according to the received volume control command.

Meanwhile, in FIG. 6B, the user terminal apparatus 100 may sense a pinch-in gesture f62 as a multi gesture of a user on the touch screen 120.

In response to the sensed pinch-in gesture f62, as illustrated in FIGS. 6C and 6D, the user terminal apparatus 100 may provide visual effects to gradually reduce the content volume control area 611. As the content volume control area 611 is reduced, visual effects to gather a plurality of UI elements 611-1, 611-2, 611-3 to be converted into one UI element 613 may be provided.

Further, as illustrated in FIG. 6D, the user terminal apparatus 100 may convert the mode into the group volume control mode in order to combine a plurality of speaker apparatuses 200-1, 200-2, 200-3 into a group such that volumes of a plurality of speaker apparatuses 200-1, 200-2, 200-3 can be jointly controlled. For example, the user terminal apparatus 100 may provide the content volume control area 611 including one UI element 613 to control a total volume corresponding to a whole of a plurality of speaker apparatuses 200-1, 200-2, 200-3. One UI element 613 may be composed of the bar and the pointer which is movable along the bar, and a pointer position on the bar may indicate a total volume of a whole of a plurality of speaker apparatuses in the group 200-1, 200-2, 200-3, as illustrated.

In this situation, when a user gesture to manipulate one UI element 613 is sensed, the user terminal apparatus 100 may determine a level of a total volume in which a whole of a plurality of speaker apparatuses in the group 200-1, 200-2, 200-3 can be controlled. For example, when the user gesture is a swipe gesture, the user terminal apparatus 100 may determine a level of a volume in which a plurality of speaker apparatuses 200-1, 200-2, 200-3 can be controlled according to a movement amount of the swipe gesture. The user terminal apparatus 100 may transmit a volume control command including information regarding the determined volume to each of a plurality of speaker apparatuses 200-1, 200-2, 200-3 or to the hub device 10 connected to the plurality of speaker apparatuses 200-1, 200-2, 200-3. In this case, the volume may be different or same in each of a plurality of speaker apparatuses 200-1, 200-2, 200-3. Each of a plurality of speaker apparatuses 200-1, 200-2, 200-3 may output music content with a volume controlled according to the received volume control command.

Next, referring to FIG. 6E, the user terminal apparatus 100 may sense a pinch-out gesture f63 as a multi gesture performed by a user on the touch screen 120.

In response to the sensed pinch-out gesture f63, as illustrated in FIG. 6F, the user terminal apparatus 100 may re-provide the individual volume control mode to enable the user to independently control individual volumes of a plurality of speaker apparatuses 200-1, 200-2, 200-3. For example, the user terminal apparatus 100 may re-display the content volume control area 611 including a plurality of UI elements 611-1, 611-2, 611-3 to control individual volumes respectively corresponding to a plurality of speaker apparatuses 200-1, 200-2, 200-3. In this case, in response to the sensed pinch-out gesture f63, the user terminal apparatus 100 may provide visual effects to gradually expand the content volume control area 611. As the content volume control area 611 expands, visual effects may be provided in which one UI element 613 may be expanded and converted into a plurality of UI elements 611-1, 611-2, 611-3.

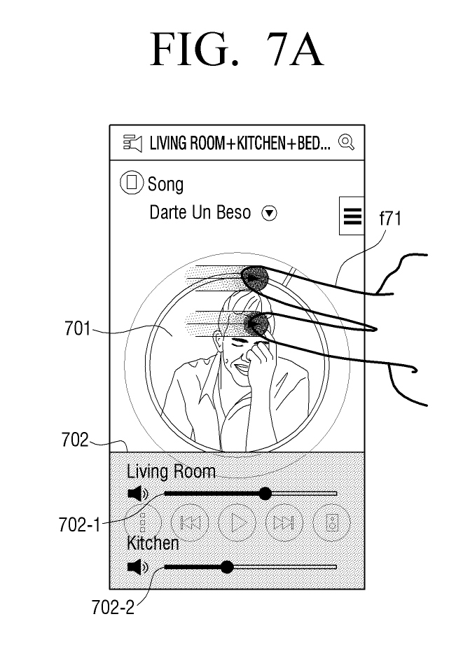

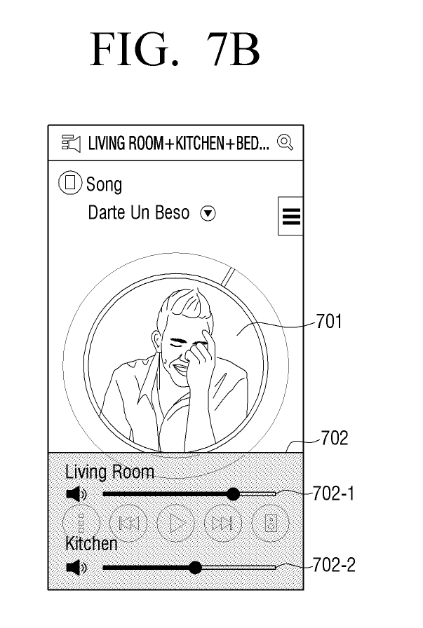

FIGS. 7A and 7B are diagrams illustrating user interface screens of the user terminal apparatus 100 to control a volume of the speaker apparatus, according to another exemplary embodiment.

Referring to FIG. 7A, the user terminal apparatus 100 may provide a screen including the content information display area 701 and the content volume control area 702. The entering into the above screen may correspond to the selecting UI element 602-1 to enter into the content volume control area 611 as illustrated in FIG. 6A, which will not be separately explained below.

In FIG. 7A, the user terminal apparatus 100 may provide the individual volume control mode to enable the user to independently control volumes of a plurality of speaker apparatuses 200-1, 200-2. In this case, the user terminal apparatus 100 may display the content volume control area 702 including a plurality of UI elements 702-1, 702-2 to control individual volumes respectively corresponding to a plurality of speaker apparatuses 200-1, 200-2. In this case, when a user gesture to manipulate one UI element among a plurality of UI elements 702-1, 702-2 is sensed, the user terminal apparatus 100 may transmit a volume control command to control a volume to the speaker apparatus corresponding to the manipulated UI element. The speaker apparatus may output music content with a volume controlled according to the received volume control command.

Meanwhile, in FIG. 7A, the user terminal apparatus 100 may sense a multi swipe gesture f71 as a multi gesture performed by a user on the touch screen 120.

In response to the sensed multi swipe gesture f71, as illustrated in FIG. 7B, the user terminal apparatus 100 may convert the mode into the group volume control mode in order to combine a plurality of speaker apparatuses 200-1, 200-2 into a group such that volumes of a plurality of speaker apparatuses 200-1, 200-2 can be jointly controlled.

Further, the user terminal apparatus 100 may move each of the pointers in a plurality of UI elements 702-1, 702-2 indicating volumes of a plurality of speaker apparatuses 200-1, 200-2 included in the content volume control area 702 in proportion to a movement amount according to the swipe of the multi swipe gesture f71. In this case, according to the multi swipe gesture f71, an increased volume of each of a plurality of speaker apparatuses 200-1, 200-2 may be the same or different. For example, an increased volume of each of a plurality of speaker apparatuses 200-1, 200-2 may be determined by considering a maximum volume of a plurality of speaker apparatuses 200-1, 200-2, or currently outputted volumes of a plurality of speaker apparatuses 200-1, 200-2 and a remaining volume to the maximum output.

Further, the user terminal apparatus 100 may transmit a volume control command including information regarding the determined volume to each of a plurality of speaker apparatuses 200-1, 200-2 or the hub device 10 connected to a plurality of speaker apparatuses 200-1, 200-2. Each of a plurality of speaker apparatuses 200-1, 200-2 may output music content with a volume controlled according to the received volume control command.

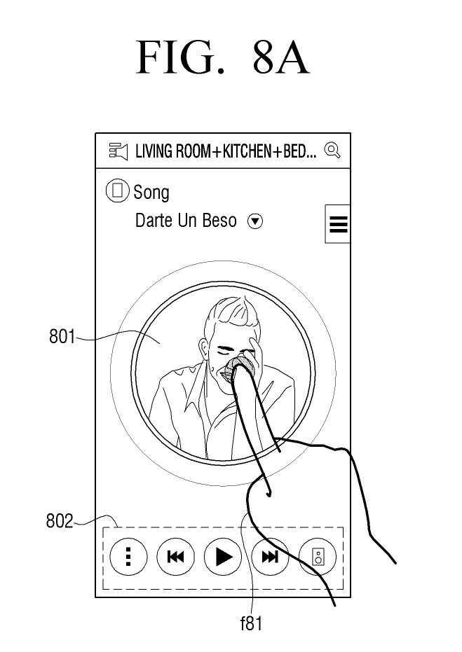

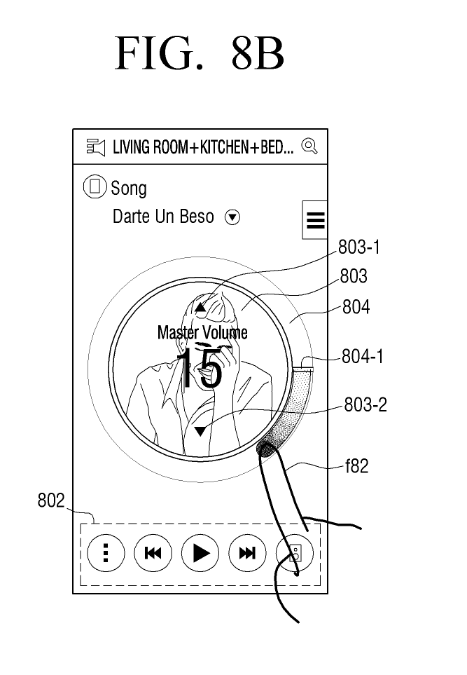

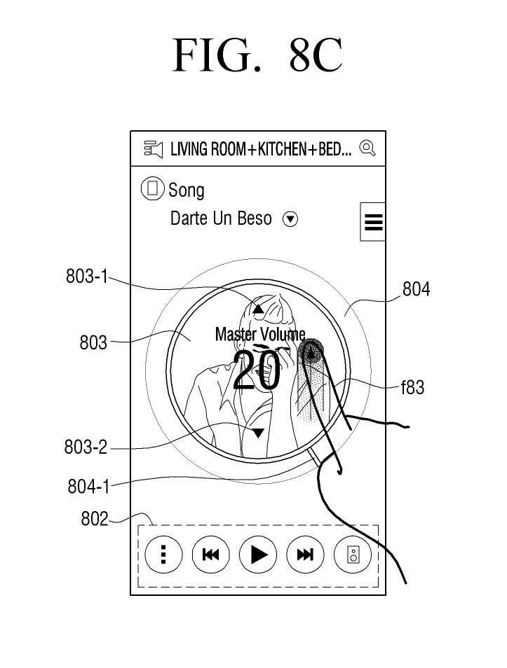

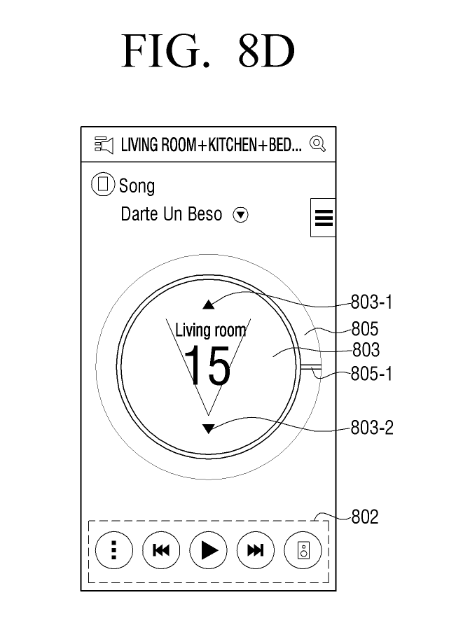

FIGS. 8A, 8B, 8C and 8D are diagrams illustrating user interface screens of the user terminal apparatus 100 to control a volume of the speaker apparatus, according to another exemplary embodiment.

Referring to FIG. 8A, the user terminal apparatus 100 may provide a screen including the content information display area 801 and the content control area 802.

In FIG. 8A, the user terminal apparatus 100 may sense a user gesture f81 to select the content information display area 801. The user gesture f81 may be a touch gesture to touch the content information display area 801, for example.

In response to the user gesture, as illustrated in FIG. 8B, the user terminal apparatus 100 may provide the group volume control mode in order to combine a plurality of speaker apparatuses 200-1, 200-2, 200-3 into a group such that volumes of a plurality of speaker apparatuses 200-1, 200-2, 200-3 can be jointly controlled. For example, the user terminal apparatus 100 may provide the content volume control area 803 including device information indicating a plurality of speaker apparatuses in the group 200-1, 200-2, 200-3 and a current volume of a plurality of speaker apparatuses in the group 200-1, 200-2, 200-3 at a position of the content information display area 801. In this case, the content volume control area 803 may be provided as a result of removing the content information display area 801, or may be provided by overlaying on the content information display area 801. Further, the content volume control area 803 may provide information regarding a current volume.

Further, the user terminal apparatus 100 may provide one UI element 804 to control a total volume corresponding to a whole of a plurality of speaker apparatuses 200-1, 200-2, 200-3 on the content volume control area 803 or an adjacent area of the content volume control area 803. As illustrated, one UI element 804 may be composed of an arc shape of the bar and the pointer which is movable along the bar, and a pointer position on the bar may indicate a cumulative volume of a plurality of speaker apparatuses in the group 200-1, 200-2, 200-3.

In this situation, the user terminal apparatus 100 may sense a user drag gesture f82 to move the pointer 804-1 of UI element 804.

In response to the user gesture f82, as illustrated in FIG. 8C, the user terminal apparatus 100 may move the pointer 804-1 of UI element 804 indicating a volume of a plurality of speaker apparatuses 200-1, 200-2, 200-3. Further, the user terminal apparatus 100 may transmit a volume control command to control a total volume of a plurality of speaker apparatuses in the group 200-1, 200-2, 200-3 to each of a plurality of speaker apparatuses 200-1, 200-2, 200-3 or to the hub device 10 connected to a plurality of speaker apparatuses 200-1, 200-2, 200-3. Each of a plurality of speaker apparatuses 200-1, 200-2, 200-3 may output music content with a volume controlled according to the received volume control command.

Next, the user terminal apparatus 100 may sense a user gesture f83 to convert the speaker apparatus controlling a volume on the content volume control area 803. For example, the user terminal apparatus 100 may sense the swipe gesture f83 in one direction of the content volume control area 803, as illustrated in FIG. 8C. Further, the user terminal apparatus 100 may sense a user tap gesture to select one from among the speaker apparatus converting UI elements 803-1, 803-2.

According to a number of user gestures, a volume controlled object may be sequentially selected. For example, when a volume controlled object is sequentially selected according to a following order of a plurality of speaker apparatuses in the group 200-1, 200-2, 200-3, the speaker apparatus at a living room, the speaker apparatus at a kitchen, and the speaker apparatus at a bedroom, and when there is no other volume controlled object to be selected, the selecting order may repeat from the start.

In response to the user gesture illustrated in FIG. 8C, as illustrated in FIG. 8D, the user terminal apparatus 100 may provide the individual volume control mode to enable the user to control a volume of one speaker apparatus among a plurality of speaker apparatuses 200-1, 200-2, 200-3.

For example, the user terminal apparatus 100 may display device information of one speaker apparatus (e.g., living room) among a plurality of speaker apparatuses 200-1, 200-2, 200-3 and a current volume of one speaker apparatus (e.g., 15) on the content volume control area 803.

Further, the user terminal apparatus 100 may provide one UI element 805 to control a volume of one speaker apparatus on the content volume control area 803 or an adjacent area with respect to the content volume control area 803. One UI element 805 may be composed of an arc shape of the bar and the pointer 805-1 which is movable along the bar, as illustrated, and a position of the pointer 805-1 on the bar may indicate a volume of one speaker apparatus.

In this case, when a user drag gesture to move the pointer 805-1 on UI element 805 is sensed, the user terminal apparatus 100 may transmit a volume control command to control a volume of one speaker apparatus to the one speaker apparatus. One speaker apparatus may output music content with a volume controlled according to the received volume control command.

Further, while providing the individual volume control mode to control a volume of one speaker apparatus, the user terminal apparatus 100 may provide the individual volume control mode to control respective volumes of the rest of a plurality of speaker apparatuses 200-1, 200-2, 200-3 in response to the user gesture (e.g., a swipe gesture to swipe from the left to the right). For example, the user terminal apparatus 100 may display device information of another speaker apparatus (e.g., bedroom) among a plurality of speaker apparatuses 200-1, 200-2, 200-3 and a current volume of another speaker apparatus (e.g., 15) on the content volume control area 803.

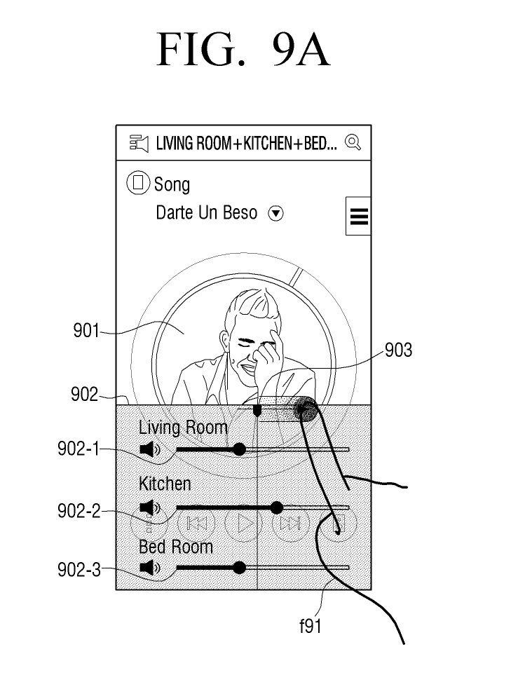

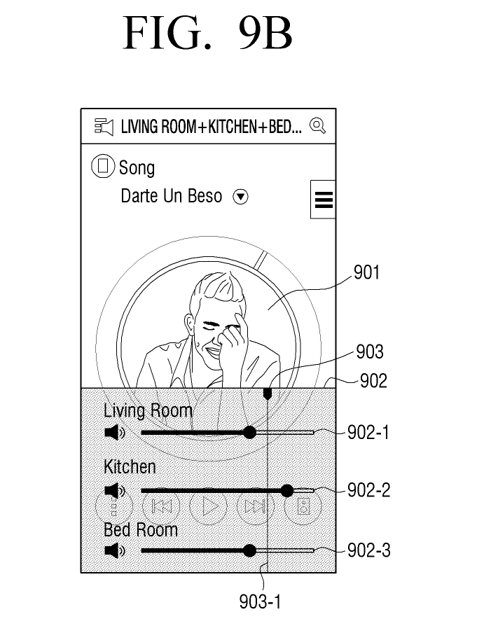

FIGS. 9A and 9B are diagrams illustrating user interface screens of the user terminal apparatus 100 to control a volume of the speaker apparatus, according to another exemplary embodiment.

Referring to FIG. 9A, the user terminal apparatus 100 may provide a screen including the content information display area 901 and the content volume control area 902. Entering into the screen may correspond to the selecting UI element 602-1 to enter into the content volume control area 611 as illustrated in FIG. 6A described above, which will not be separately explained below.

In FIG. 9A, the user terminal apparatus 100 may display the content volume control area 902 including a plurality of UI elements 902-1, 902-2, 902-3 to control individual volumes corresponding to each of a plurality of speaker apparatuses 200-1, 200-2, 200-3. When a user gesture to manipulate one UI element among a plurality of UI elements 902-1, 902-2, 902-3 is sensed, the user terminal apparatus 100 may transmit a volume control command to control a volume to the speaker apparatus corresponding to the manipulated UI element. The speaker apparatus may output music content with a volume controlled according to the received volume control command.

Further, as illustrated in FIG. 9A, the user terminal apparatus 100 may display the content volume control area 902 including one UI element 903 to control a cumulative volume corresponding to a whole of a plurality of speaker apparatuses 200-1. 200-2, 200-3. One UI element 903 may be composed of the pointer which is movable as illustrated, and a pointer position may indicate a cumulative volume of a plurality of speaker apparatuses in the group 200-1, 200-2, 200-3.

Next, the user terminal apparatus 100 may sense a drag gesture f91 of a user to move the pointer of one UI element 903.

In response to the user gesture f91, as illustrated in FIG. 9B, the user terminal apparatus 100 may move the pointer of UI element 903. Further, in response to the pointer moving of UI element 903, the user terminal apparatus 100 may move the pointers of UI elements 902-1, 902-2, 902-3 indicating respective volumes of a plurality of speaker apparatuses 200-1, 200-2, 200-3. In this case, in order to indicate a movement degree of the pointers 902-1, 902-2, 902-3 of UI elements in each of the speaker apparatuses 200-1, 200-2, 200-3 according to the amount of movement of the pointer of one UI element 903 to control a total volume, a vertical guide bar 903-1 may be additionally displayed on the pointer of one UI element 903.

Meanwhile, although the above exemplary embodiment describes that the group volume control mode is a mode which relates to controlling a total volume of all of a plurality of speaker apparatuses 200-1, 200-2, 200-3, this is merely one of various exemplary embodiments; for example, the group volume control mode may be a mode to control volumes of the first speaker apparatus 200-1 and the second speaker apparatus 200-2 among a plurality of speaker apparatuses 200-1, 200-2, 200-3. Herein, a user may select at least two speaker apparatuses to be controlled by using the group volume control mode.

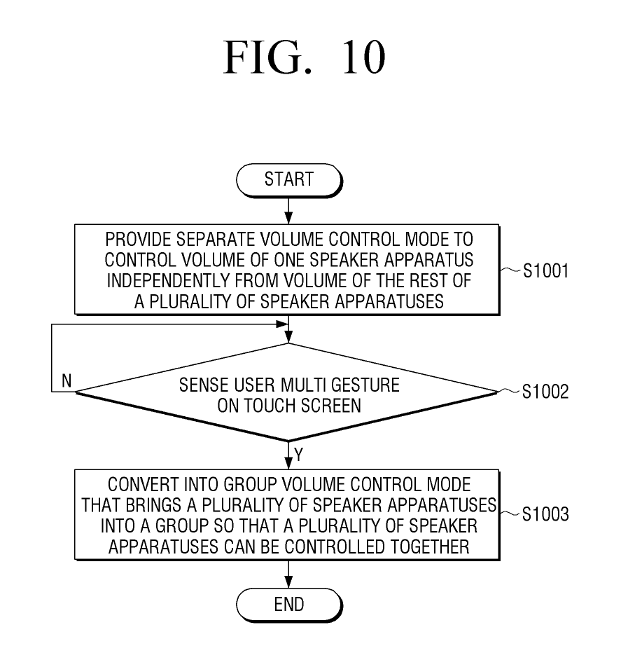

FIG. 10 is a flowchart in which the user terminal apparatus 100 controls a volume of the speaker apparatus, according to an exemplary embodiment.

In operation S1001, the user terminal apparatus 100 may provide the individual volume control mode (also referred to herein as a “separate volume control mode”) to control a volume of one speaker apparatus independently with respect to respective volumes of the rest of a plurality of speaker apparatuses 200-1, 200-2, 200-3.

In this case, the user terminal apparatus 100 may display a plurality of UI elements to enable separate and independent control of individual volumes which respectively correspond to a plurality of speaker apparatuses 200-1, 200-2, 200-3.

While the individual volume control mode is provided, in operation S1002, the user terminal apparatus 100 may determine whether a user multi gesture is sensed on the touch screen. Herein, the multi gesture may be a pinch-in gesture of gathering fingers while multi-touching the touch screen 120 or a multi swipe gesture of swiping in one direction while multi-touching the touch screen 120.

As a determining result, when multi gesture is sensed at operation S1002-Y, in operation S1003, the user terminal apparatus 100 may convert the mode into the group volume control mode in order to combine a plurality of speaker apparatuses 200-1, 200-2, 200-3 into a group such that volumes of a plurality of speaker apparatuses 200-1, 200-2, 200-3 can be jointly controlled in response to the sensed multi gesture. In this case, the user terminal apparatus 100 may display one UI element to control a total volume corresponding to a whole of a plurality of speaker apparatuses 200-1, 200-2, 200-3 on the screen.

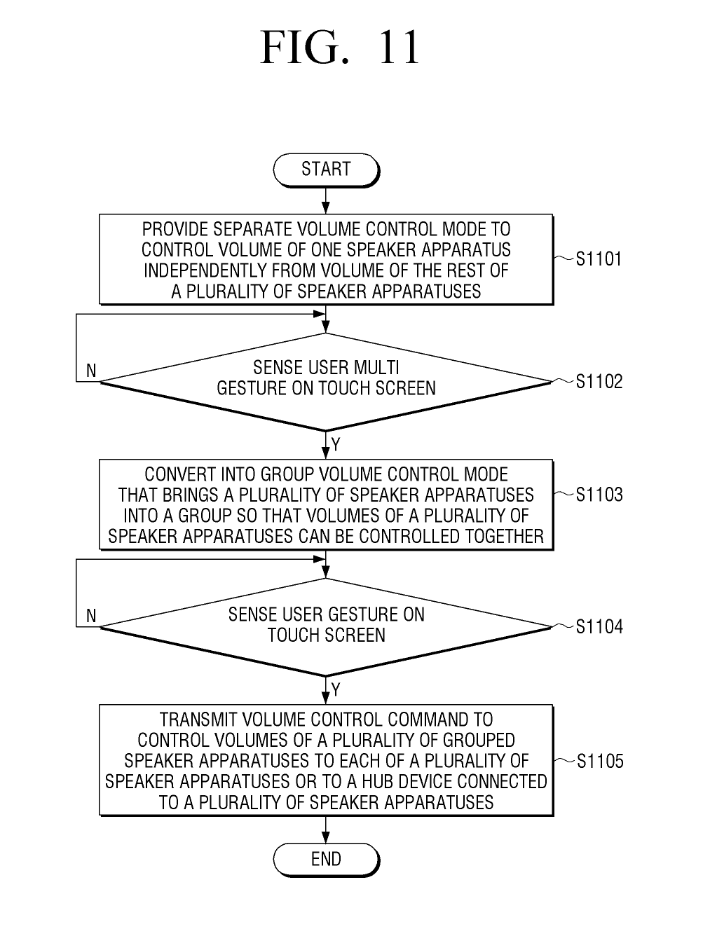

FIG. 11 is a flowchart in which the user terminal apparatus 100 controls a volume of the speaker apparatus, according to another exemplary embodiment.

In operation S1101, the user terminal apparatus 100 may provide the individual volume control mode (also referred to herein as a “separate volume control mode”) to control a volume of one speaker apparatus independently from a volume of the rest of a plurality of speaker apparatuses 200-1, 200-2, 200-3.

In this case, the user terminal apparatus 100 may display a plurality of UI elements to enable the user to control individual volumes respectively corresponding to a plurality of speaker apparatuses 200-1, 200-2, 200-3.

While the individual volume control mode is provided, in operation S1102, the user terminal apparatus 100 may determine whether a user multi gesture is sensed on the touch screen 120. Herein, the multi gesture may be a pinch-in gesture of gathering fingers while multi-touching the touch screen 120 or a multi swipe gesture of swiping in one direction while multi-touching the touch screen 120.

As a determining result, when multi gesture is sensed in operation S1102-Y, in operation S1103, the user terminal apparatus 100 may convert the mode into the group volume control mode in order to combine a plurality of speaker apparatuses 200-1, 200-2, 200-3 into a group such that volumes of a plurality of speaker apparatuses 200-1, 200-2, 200-3 can be jointly controlled in response to the sensed multi gesture. In this case, the user terminal apparatus 100 may display one UI element to control a total volume corresponding to a whole of a plurality of speaker apparatuses 200-1, 200-2, 200-3 on the screen.

While converting into the group volume control mode, in operation S1104, the user terminal apparatus 100 may determine whether a user gesture is sensed on the touch screen 120. The user gesture may be, for example, a gesture of swiping the multi gesture or a user single gesture sensed again after the touch of the multi gesture is lifted off.

As a determining result, when user gesture is sensed again in operation S1104-Y, in operation S1105, the user terminal apparatus 100 may transmit a volume control command to control volumes of a plurality of speaker apparatuses in the group 200-1, 200-2, 200-3 to each of a plurality of speaker apparatuses 200-1, 200-2, 200-3 or to the hub device 10 connected to a plurality of speaker apparatuses 200-1, 200-2, 200-3 in response to the sensed user gesture. In this case, based on a movement amount of the user gesture, a volume to control each of a plurality of speaker apparatuses 200-1, 200-2, 200-3 may be determined.

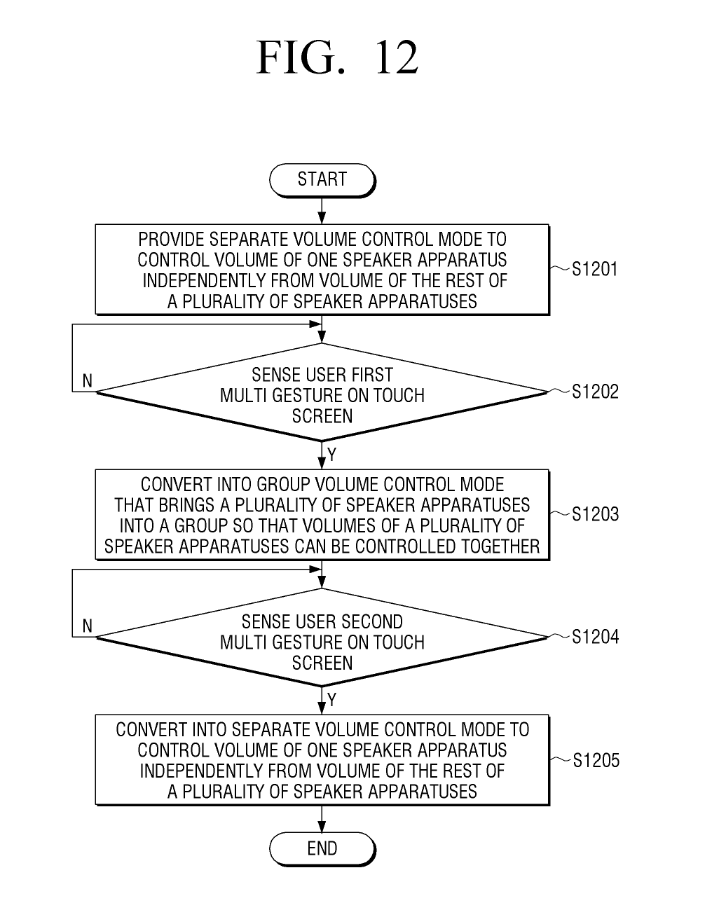

FIG. 12 is a flowchart in which the user terminal apparatus 100 controls a volume of the speaker apparatus, according to another exemplary embodiment.

In operation S1201, the user terminal apparatus 100 may provide the individual volume control mode (also referred to herein as a “separate volume control mode”) to control a volume of one speaker apparatus independently from a volume of the rest of a plurality of speaker apparatuses 200-1, 200-2, 200-3.

In this case, the user terminal apparatus 100 may display a plurality of UI elements to enable the user to control individual volumes respectively corresponding to a plurality of speaker apparatuses 200-1, 200-2, 200-3.

While the individual volume control mode is provided, in operation S1202, the user terminal apparatus 100 may determine whether a first multi gesture of a user is sensed on the touch screen 120. Herein, the first multi gesture may be a pinch-in gesture of gathering fingers while multi-touching the touch screen 120.

As a determining result, when multi gesture is sensed in operation S1202-Y, in operation S1203, the user terminal apparatus 100 may convert the mode into the group volume control mode in order to combine a plurality of speaker apparatuses 200-1, 200-2, 200-3 into a group such that volumes of a plurality of speaker apparatuses 200-1, 200-2, 200-3 can be jointly controlled in response to the sensed multi gesture. In this case, the user terminal apparatus 100 may display one UI element to control a total volume in correspondence with a whole of a plurality of speaker apparatuses 200-1, 200-2, 200-3 on the screen.

While converting into the group volume control mode, in operation S1204, the user terminal apparatus 100 may determine whether a second multi gesture of a user is sensed on the touch screen 120. Herein, the second multi gesture may be a pinch-out gesture of spreading fingers while multi-touching the touch screen 120.

As a determining result, when second multi gesture is sensed in operation S1204-Y, in operation S1205, the user terminal apparatus 100 may re-convert the mode into the individual volume control mode to enable the user to control a volume of one speaker apparatus independently from a volume of the rest of a plurality of speaker apparatuses 200-1, 200-2, 200-3 in response to the sensed user gesture. In this case, the user terminal apparatus 100 may re-display a plurality of UI elements to enable the user to control individual volumes respectively corresponding to a plurality of speaker apparatuses 200-1, 200-2, 200-3 on the screen.

At least a portion of devices (e.g., modules or functions thereof) or methods (e.g., operations) according to the various exemplary embodiments may be implemented to be a program module format of commands stored in a transitory or non-transitory computer readable recording medium.

The term “module” may indicate, for example, a unit that includes one or a combination of two or more from among hardware, software or firmware. The term “module” may be interchangeably used with terms such as unit, logic, logical block, component or circuit. A module may be a minimum unit or a part of integrated units. A module may be also a minimum unit or a part that is configured to perform one or more functions. A module may be implemented mechanically or electronically. For example, a module may include at least one among an application-specific integrated circuit chip (ASIC), field-programmable gate arrays (FPGAs) or a programmable-logic device which is known or will be developed for performance of operation.

Meanwhile, when the commands are performed by the controller 130, at least one of the above-described processor may perform a corresponding function based on the commands. The computer readable recording medium may be, for example, the storage 140.

The computer readable recording medium may include a hard disc, a floppy disc, magnetic media (e.g., magnetic tape), optical media (e.g., compact disc read only memory (CD-ROM), digital versatile disc (DVD), magneto-optical media (e.g., floptical disc)), and hardware device (e.g., ROM, random access memory (RAM), or flash memory). Further, the program commands may include high language codes that can be performed by a computer using the interpreter as well as mechanical codes created by a compiler. The above-described hardware device may be constituted to operate as one or more software modules in order to perform operation of the various exemplary embodiments, and vice versa.

According to the various exemplary embodiments, in the computer readable recording medium that stores the commands, the commands may be established such that at least one processor can perform at least one operation when the commands are executed by at least one processor. At least one operation may include providing the individual volume control mode to control a volume of one speaker apparatus independently from a volume of the rest of a plurality of speaker apparatuses, and converting into the group volume control mode in order to combine a plurality of speaker apparatuses into a group such that volumes of a plurality of speaker apparatuses can be jointly controlled in response to the sensed multi-part gesture on the touch screen while the individual volume control mode is provided.

Modules or program modules according to the above-described exemplary embodiments may include at least one among the above described elements, remove some elements or include additional other elements. Modules according to the various exemplary embodiments, program modules, or operations conducted by the other elements may be performed with a sequential, parallel, repeat or heuristic method. Further, some operations may be performed or deleted according to a different order, or another operation may be added.

The foregoing exemplary embodiments and advantages are merely exemplary and are not to be construed as limiting the exemplary embodiments. The present disclosure can be readily applied to other types of apparatuses. Also, the description of the exemplary embodiments is intended to be illustrative, and not to limit the scope of the claims.

What is claimed is:

1. A user terminal apparatus configured to convert a mode that relates to controlling volumes of a plurality of speaker apparatuses, comprising:
a touch screen configured to sense a gesture that is performed by using at least two input tools; and
a controller configured to provide an individual volume control mode that relates to controlling a volume of a single speaker apparatus independently with respect to respective volumes of a remainder of the plurality of speaker apparatuses, and to convert the mode into a group volume control mode in order to combine the plurality of speaker apparatuses into a group such that volumes of the plurality of speaker apparatuses can be jointly controlled in response to the sensed gesture while the individual volume control mode is provided.

2. The user terminal apparatus of claim 1, wherein, when the individual volume control mode is provided, the controller is further configured to control the touch screen to display a plurality of user interface (UI) elements which respectively correspond to controlling individual volumes which respectively relate to corresponding ones from among the plurality of speaker apparatuses.

3. The user terminal apparatus of claim 1, wherein, when the group volume control mode is provided, the controller is further configured to control the touch screen to display one user interface (UI) element which corresponds to controlling a total volume that relates to a whole of the plurality of speaker apparatuses.

4. The user terminal apparatus of claim 1, further comprising:
a communication interface configured to communicate with the plurality of speaker apparatuses or with a hub device connected to the plurality of speaker apparatuses,
wherein the touch screen is further configured to sense a user gesture on the touch screen while the mode is being converted into the group volume control mode, and
the controller is further configured to control the communication interface to transmit a volume control command which relates to controlling respective volumes of the plurality of speaker apparatuses in the group to each of the plurality of speaker apparatuses or to the hub device in response to the sensed user gesture.

5. The user terminal apparatus of claim 4, wherein the user gesture includes one from among a gesture of swiping the gesture that is performed by using at least two input tools and a user gesture sensed again after the touch of the gesture that is performed by using at least two input tools is ended.

6. The user terminal apparatus of claim 4, wherein the controller is further configured to determine a level of each respective volume of the plurality of speaker apparatuses according to a movement amount of the user gesture.

7. The user terminal apparatus of claim 1, further comprising:
a communication interface configured to communicate with the plurality of speaker apparatuses or with a hub device connected to the plurality of speaker apparatuses,
wherein the touch screen is further configured to sense a user gesture while the individual volume control mode is provided, and
the controller is further configured to control the communication interface to transmit a volume control command that relates to controlling a volume of one speaker apparatus among the plurality of speaker apparatuses to the one speaker apparatus or to the hub device in response to the sensed user gesture.

8. The user terminal apparatus of claim 1, wherein the controller is further configured to convert the mode into the individual volume control mode in response to the gesture that is performed by using at least two input tools being sensed by the touch screen while the group volume control mode is provided.

9. The user terminal apparatus of claim 1, wherein the gesture that is performed by using at least two input tools includes one from among a pinch-in gesture of gathering fingers while touching the touch screen with at least two input tools, and a swipe gesture of swiping in one direction while touching the touch screen with at least two input tools.

10. A sound output system, comprising:
a plurality of speaker apparatuses; and
a user terminal apparatus configured to provide an individual volume control mode that relates to controlling a volume of a single speaker apparatus independently with respect to respective volumes of a remainder of the plurality of speaker apparatuses, and to convert the mode into a group volume control mode in order to combine the plurality of speaker apparatuses into a group such that volumes of the plurality of speaker apparatuses can be jointly controlled when a gesture that is performed by using at least two input tools is sensed while the individual volume control mode is provided.

11. A mode conversion method that is performable a user terminal apparatus which is configured for controlling volumes of a plurality of speaker apparatuses, the method comprising:
providing an individual volume control mode that relates to controlling a volume of a single speaker apparatus independently with respect to respective volumes of a remainder of the plurality of speaker apparatuses;
sensing a gesture that is performed by using at least two input tools of a user on a touch screen while the individual volume control mode is provided; and
converting the mode into a group volume control mode in order to combine the plurality of speaker apparatuses into a group such that volumes of a plurality of speaker apparatuses can be jointly controlled in response to the sensed gesture that is performed by using at least two input tools.

12. The mode conversion method of claim 11, wherein the providing the individual volume control mode comprises displaying, on a screen, a plurality of user interface (UI) elements which respectively correspond to controlling individual volumes which respectively relate to corresponding ones from among the plurality of speaker apparatuses.

13. The mode conversion method of claim 11, wherein the converting the mode into the group volume control mode comprises displaying, on a screen, one user interface (UI) element which corresponds to controlling a total volume that relates to a whole of the plurality of speaker apparatuses.

14. The mode conversion method of claim 11, further comprising:
sensing a user gesture on the touch screen while the mode is being converted into the group volume control mode; and
transmitting a volume control command which relates to controlling respective volumes of the plurality of speaker apparatuses in the group to each of the plurality of speaker apparatuses or to a hub device connected to a plurality of speaker apparatuses in response to the sensed user gesture.

15. The mode conversion method of claim 14, wherein the user gesture includes one from among a gesture of swiping the gesture that is performed by using at least two input tools and a user gesture sensed again after the touch of the gesture that is performed by using at least two input tools is ended.

16. The mode conversion method of claim 14, further comprising:
determining a level of each respective volume of the plurality of speaker apparatuses according to a movement amount of the user gesture.

17. The mode conversion method of claim 11, further comprising:
sensing a user gesture on the touch screen while the individual volume control mode is provided; and
transmitting a volume control command that relates to controlling a volume of one speaker apparatus among the plurality of speaker apparatuses to the one speaker apparatus or to a hub device connected to the one speaker apparatus in response to the sensed user gesture.

18. The mode conversion method of claim 11, further comprising:
converting the mode into the individual volume control mode in response to the gesture that is performed by using at least two input tools being sensed on the touch screen while the group volume control mode is provided.

19. The mode conversion method of claim 11, wherein the gesture that is performed by using at least two input tools includes one from among a pinch-in gesture of gathering fingers while touching the touch screen with at least two input tools, or a swipe gesture of swiping in one direction while touching the touch screen with at least two input tools.
